(19) United States
(12) Patent Application Publication
(10) Pub. No.: US 2019/0266522 A1
(43) Pub. Date: Aug. 29, 2019

(54) Vehicle-Based Services

(71) Applicant: Chian Chiu Li, Fremont, CA (US)

(72) Inventor: Chian Chiu Li, Fremont, CA (US)

(21) Appl. No.: 15/903,043

(22) Filed: Feb. 23, 2018

(51) Int. Cl. G06Q 10/02; G06Q 30/06; G06Q 10/08; H04W 4/44

(52) U.S. Cl. CPC G06Q 10/025; G06Q 30/0641; G06Q 50/10; H04W 4/44; G06Q 10/0832

(57) ABSTRACT

System and method for providing vehicle-based services. Hailed vehicles are arranged to provide food, massage, medical, and parcel-delivery services. Using a ship-to-vehicle method, a parcel is delivered to an occupant of a hailed vehicle. In one aspect, a ship-to-vehicle option is presented in a purchasing interface. In another aspect, an alert signal is presented in a vehicle-hailing interface when a parcel is ready for delivery. Options are also provided for a user to select a trip segment as a parcel-delivery window.

### FEDERALLY SPONSORED RESEARCH

Not applicable

### SEQUENCE LISTING OR PROGRAM

Not applicable

### BACKGROUND

### Field of Invention

This invention relates to vehicle-based services, more particularly to vehicle-based parcel-delivery services.

### Description of Prior Art

Autonomous vehicle (also known as driverless or self-driving vehicle) is a vehicle capable of sensing and navigating around the vehicle's surroundings and travelling autonomously to a destination without user input. It represents a great advance in the transportation industry.

When autonomous vehicles become widely available, many users may rely on self-driving taxis or self-driving shared cars, instead of driving by themselves. A large number of users who frequently take an autonomous vehicle to places may create a sizable demand for certain services. For instance, when a user in a vehicle doesn't drive, the user may have time for a rest or a need to do certain things. However, current taxies or shared cars function as a transportation tool only. They rarely provide other services.

Therefore, there exists a need for certain services provided for an occupant in a vehicle, especially in an autonomous vehicle.

Currently, a user needs to submit a shipping address or delivery address before placing an online purchase order. It may be a residential address or business address. Since a user may not be at home when a parcel arrives and may not want to use a work place as a shipping or delivery address due to privacy concerns, receiving a parcel may become a concern or issue after a purchase is made. Meanwhile, when a user hails a vehicle, the exact location of the user is known to a ride-hailing company, i.e., in a hailed vehicle. And the user may stay in the vehicle for a while.

Therefore, there exist a need for a delivery method and a need to make use of a hailed vehicle.

As used herein, word “vehicle” may mean any form of motorized transportation. Examples of vehicle may include automobile, drone, flying car, aircraft, and ship. For convenience of description, it may be arranged that “Service Center” as used herein may mean a center or remote facility as a business entity or a server which is operated at Service Center. “Check in” as used herein may mean a user logs in a system at a vehicle using info obtained from a reservation or using other suitable info. In one scenario, after a check-in process, the identity of a user may be confirmed. In another scenario, after a check-in process, the identity of a user may remain unknown. “Parcel” as used herein may mean any package which is sent to a user. A parcel may come from a seller and contain a product or an order which a user purchased online or at a retail store. A parcel may also mean a package containing dishes from a restaurant. “Hailing (hail) a vehicle” and “Hail a car” as used herein may mean an action or online process performed by a user to order a vehicle for renting purpose or reserve a vehicle for present or future use.

### OBJECTS AND ADVANTAGES

Accordingly, several main objects and advantages of the present invention are:
a). to provide improved services for an occupant of a vehicle;
b). to provide such services which include food, massage, medical, and parcel-delivery aspects;
c). to provide such services which enable delivering a parcel to an occupant of a hailed vehicle;
d). to provide such services which enable a ship-to-vehicle method at an e-commerce website; and
e). to provide such services which present an alert signal in a vehicle-hailing interface when a parcel is ready for delivery.

Further objects and advantages will become apparent from a consideration of the drawings and ensuing description.

### SUMMARY

In accordance with the present invention, vehicle-based services are provided for a user. The services include cooking, massage, medical checkup and treatment, and parcel delivery. With a ship-to-vehicle method, a parcel is delivered to an occupant of a vehicle. An alert icon is configured in a vehicle-hailing interface to inform a user that a parcel is ready for delivery. A ship-to-vehicle option is arranged in a purchasing interface. In addition, options are provided for a user to choose a segment of a trip as a parcel-delivery window.

### DRAWING FIGURES

FIG. 1-A is an exemplary diagram describing an embodiment involving a vehicle, a client system, and a server in accordance with the present invention.

FIGS. 1-B and 1-C are exemplary diagrams which depict a client system and a vehicle respectively in accordance with the present invention.

FIGS. 2 and 3 are exemplary diagrams which illustrate settings of a vehicle-hailing interface in accordance with the present invention.

FIG. 4 is a flow diagram depicting an exemplary vehicle-hailing process in accordance with the present invention.

FIG. 5 is a flow diagram depicting an exemplary vehicle-dispatching process in accordance with the present invention.

FIGS. 6 and 7 are exemplary diagrams which illustrate interface settings for selecting food services in accordance with the present invention.

FIG. 8 is an exemplary diagram which illustrates an interface for submitting shipping information in accordance with the present invention.

FIG. 9 is a flow diagram depicting an exemplary parcel-delivery process in accordance with the present invention.

FIG. 10 uses exemplary diagrams to describe steps to transfer a parcel from a drone to a vehicle in accordance with the present invention.

### REFERENCE NUMERALS IN DRAWINGS

| | | | |
|---|---|---|---|
| 10 | Processor | 12 | Computer Readable Medium |
| 14 | Communication Network | 16 | Client System |
| 18 | Vehicle | 20 | Processing Module |
| 22 | Database | 24 | Server |
| 26 | Smartphone | 28 | Screen |
| 30 | Button | 32 | Button |
| 34 | Button | 36 | Button |
| 38 | Button | 40 | Button |
| 42 | Button | 44 | Button |
| 46 | Button | 48 | Button |
| 50 | Smartphone | 52 | Screen |
| 54 | Button | 56 | Button |
| 58 | Button | 60 | Button |
| 62 | Button | 64 | Button |
| 66 | Window | 68 | Smartphone |
| 70 | Screen | 72 | Check Box |
| 74 | User Input Area | 76 | Window |
| 78 | Check Box | 80 | Check Box |
| 82 | Vehicle | 84 | Landing Pad |
| 86 | Door | 88 | Parcel |
| 90 | Drone | 92 | Window |
| 94 | Window | 96 | Window |
| 98 | Button | | |

100-168 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

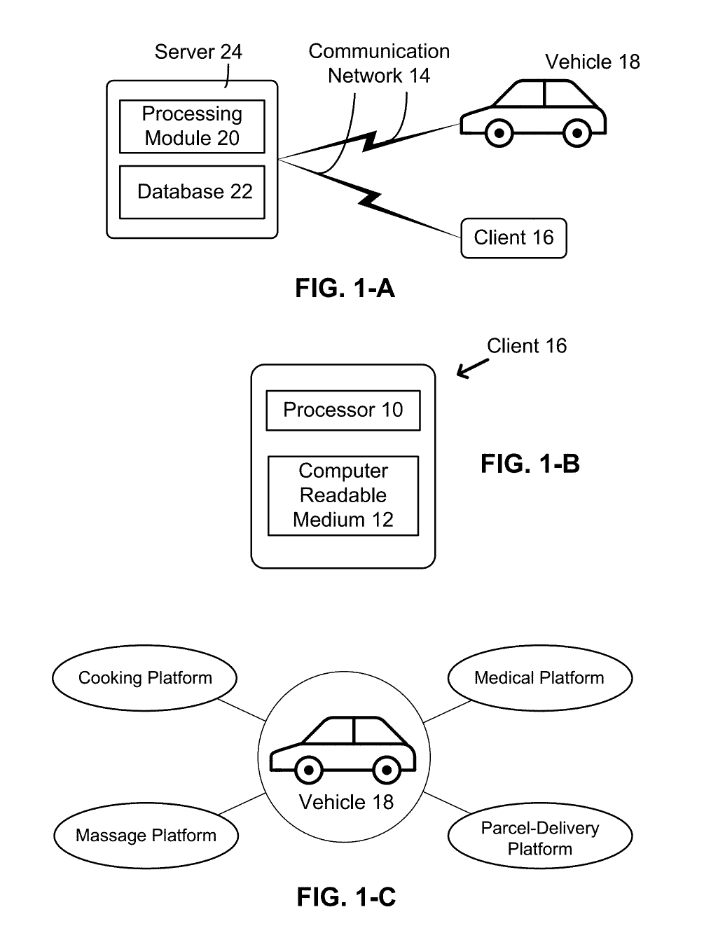

FIG. 1-A is an exemplary block diagram of one embodiment according to the present invention. A vehicle 18 and server 24 are connected via a wireless communication network 14. So are a client system 16 and server 24. Assume that server 24 is installed at Service Center. Service Center is arranged as a ride-hailing company which administers vehicles including vehicle 18 and processes hailing requests from users. The word “server” as used in here means a system or systems which may have similar functions and capacities as one or more servers. Server 24 may exemplarily be divided into two blocks, represented by a processing module 20 and database 22. Processing module 20 may include processing and communication functions. Database 22 may store vehicle service records and information, map data and geographic info of certain areas, user account information, user transaction records, etc. The database may include a cluster of memory chips and/or storage modules. In the figure, servers 24 may represent a device that collects, processes, stores, and maintains information and documents, sends instructions to vehicles, transmits messages to users, executes tasks requested by users, etc.

FIG. 1-B describes client system 16 exemplarily. Client system 16 may cover a range of electronic devices and gadgets, e.g., a desktop computer, a notebook computer, a tablet computer, a smartphone, a smart watch, a virtual reality (VR) device, an augmented reality (AR) device, and the like. Client system 16 may include a processor 10 and computer readable medium 12. Processor 10 may mean one or more processor chips or systems. Medium 12 may be the main part of a storage system and may include a memory hierarchy built by one or more memory chips or storage components like RAM, ROM, FLASH, or other suitable storage modules. Processor 10 may run programs or sets of executable instructions stored in medium 12 for performing various functions and tasks like surfing on the Internet, placing purchase orders, hailing a vehicle, sending and receiving emails and short messages, playing video or music, etc. Client system 16 may also include input, output, and communication components, which may be individual modules or integrated with processor 10.

In addition, client system 16 may have a display (not shown in the figure for brevity reason) and a graphical user interface (GUI). The display may have a liquid crystal display (LCD) screen or light emitting diode (LED) screen and may be arranged sensitive to touches, i.e., sensitive to haptic and/or tactile contact with a user. A user may use the interface to interact with online sellers, restaurant ordering systems, Service Center or server 24, and so on. Via client system 16, for instance, a user may place orders, select a shipping option, hail a vehicle, choose a vehicle-based service, and specify a trip segment for parcel delivery.

Furthermore, client system 16 may have a voice recognition device to receive a user's verbal command or voice input. The system may have facial recognition capability to recognize a user. And the system may also have a gesture detection mechanism to receive a user's gesture instructions. For VR and AR devices and some wearable devices, a virtual screen or a screen with a very small size may be arranged. A virtual screen may be part of a displaying system that doesn't have a physical screen. When it is impractical or inconvenient to touch a virtual screen or very small screen, a user may use voice command and gesture instructions to interact with a system.

FIG. 1-C illustrates vehicle 18 and business platforms it may provide schematically. The vehicle may have various sensors (not shown in the figure) to detect an external environment and internal situation. The sensors may include cameras, a radar system, a light detection and ranging (LIDAR) system, a global position system (GPS), a speed sensor, an accelerometer, an electronic compass, etc. Vehicle 18 may also have a control system. Like client system 16, the control system may have a computer processor, a storage device, a display with a touch sensitive screen, a voice recognition system, a facial recognition system, and a gesture detection system. It is noted that voice, facial, and gesture recognition technologies are all mature nowadays. The control system may use the sensors to navigate vehicle 18 to a destination, implement a task submitted by an occupant, and interact with an occupant. Moreover, as shown in the figure, vehicle 18 may have business platforms which provide additional services, such as food service, massage service, medical service, and parcel-delivery service.

A cooking platform may function as a deli and a miniature kitchen. For instance, a cooking platform may have a freezer and refrigerator for food storage, an oven for baking and broiling, a frying pan for frying, a boiler for boiling or steaming, and a microwave oven for quick heating. A robotic handler may be installed inside a vehicle which may do picking, mixing, wrapping, and other kitchen jobs. Dishes which are suitable for a small vehicle may include sandwich, hamburger, pizza, hot dog, French fries, hot soup, spaghetti, etc. A vehicle's cooking platform may not only provide freshly-cooked food, but also save time for a user, as a trip to a restaurant and waiting in a line are avoided.

A massage platform may be arranged to provide massaging services for an occupant. For instance, a vehicle seat may be designed to provide massaging functions. There are massaging chairs at the market. Those chairs may be modified to fit a vehicle. Massage services may make a trip more relaxed and comfortable,

A medical platform may be designed to provide certain medical checkups, diagnosis, and treatments. For instance, certain mature medical equipment and devices may be modified and installed in a vehicle. The equipment and devices may measure an occupant's heart rate, blood pressure, body temperature, blood glucose, cardiogram, and so on. The equipment may be designed to diagnose certain diseases like cold, flu and fever and a user may use the diagnosis as a preliminary step before going to see a doctor. The equipment may also perform relatively simple tasks like flu shot injection or removal of certain moles on an occupant's skin. Medical services may be desirable for some users who are concerned with their health and some users who need certain diagnosis and treatment but are reluctant to schedule an appointment at a doctor's office. As some medical services need a stable environment, a vehicle may be arranged to slow down below a given speed or stop at a place before performing a medical task. For instance, a vehicle control system may present a message on a display to an occupant. The message may be like “Vehicle will stop shortly. Be prepared for flu shot.” Then, the vehicle may stop at a stopping place or parking lot and the control system may start a medical service.

A parcel-delivery platform may be configured to receive a parcel and pass it to an occupant. After a user schedules a trip, the whereabouts of the user in a time frame may be forecasted. If Service Center has info that there is a parcel ready for delivery to the user, the center may send the parcel to a vehicle which the user will take or is riding in. Hence, the user may receive the parcel while riding in the vehicle during a journey. Currently, a shipping company has no knowledge about a recipient's location. Whether a recipient is at home, at work, at a school, or at a shopping mall, a shipping company has no information. Lack of info about a recipient's location may no longer exist for certain users when they hail a vehicle frequently. Use of a hailing request to predict a user's location in advance may not only enable secured parcel delivery, but also cause less privacy concerns, as Service Center knows it already. When such an opportunity is utilized, it makes a delivery securer than home delivery, since nobody may be at home when a parcel arrives.

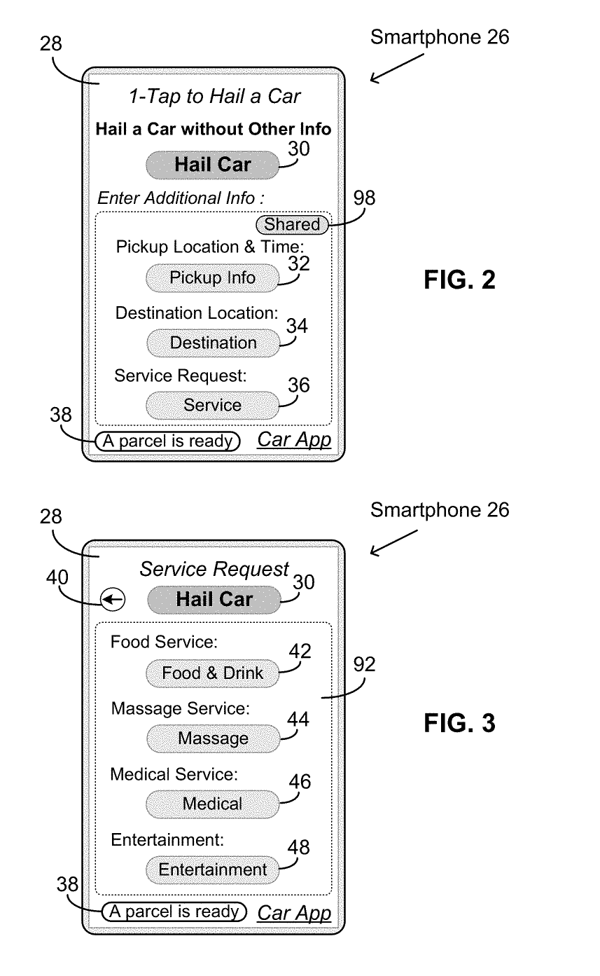

Although a service may be requested by many users, only a limited number of vehicles may be well equipped to provide it. Thus, a user may have to request a service as an extra demand during a vehicle hailing process. FIG. 2 shows an exemplary diagram of an app interface which enables service selections. Assume that Car App is installed at a smartphone 26. The app may be provided by Service Center for hailing or reserving a vehicle. As in the figure, contents in the app interface are shown on a touch-sensitive screen 28. There are interactive elements or buttons 30, 32, 34, 36, and 98. The top portion of the interface is configured for a simple and quick hailing process which requires one action only. The first line shows a title, like a sentence “1-Tap to Hail a Car”. The second line gives a concise explanation “Hail a Car without Other Info”. Button 30 has a label “Hail Car”.

The app is designed such that a user may directly tap button 30 to complete a vehicle hailing process without submitting pickup location, pickup time, destination location, or other information. Assume that a user has an account at Service Center and enables a location option at phone 26. Assume that when the location option is enabled, phone 26 turns on GPS or uses another positioning mechanism to get its location info. After the user launches Car App, an interface like the one in FIG. 2 appears. Since the phone's location is measured constantly, the app has data of the current location. Once the user taps button 30, it prompts the app to send a message to Service Center. The message may contain at least three items: A user's account number, data of current location, and a request for a vehicle. Service Center may assume that the user needs a vehicle right now and a pickup place may be the user's current location or a nearby place if the current location is not suitable for pickup. Next Service Center may select and dispatch a vehicle to pick up the user and send a message to the user in the meantime. The message may show up in the app interface with contents like when a car will come and where a pickup place will be. If the user closes the app after tapping button 30, Service Center may send the user an email or a short message containing similar information.

As a user only needs to tap button 30 after the app is launched, hailing a vehicle may become simple, quick, and convenient. Such a one-tap-to-hail-a-car process especially fits autonomous vehicles. For instance, before a taxi with a driver is dispatched, the driver's work area and work schedule have to be reviewed. Some drivers may not be available for a long trip or a trip to a specific area. On the contrary, autonomous vehicles don't have such limiting factors. They may be treated relatively equal. Therefore, an autonomous vehicle may be sent to a user without knowing destination info and without worrying about where the user will go.

When a user taps button 30 without entering other info, a hailing request is made under the assumption that the user needs a vehicle assigned to one party only. If a user wants to save money, the user may share a vehicle with one or more parties. Button 98, with an exemplary label “Shared”, may be configured in the interface as an option for a shared vehicle. The button may have similar brightness to other buttons initially. Once the button is tapped, it may be lightened, showing a request for a shared vehicle is entered. It is noted that destination info is needed for requesting a shared vehicle, as Service Center couldn't pair users without knowing whether they head for similar directions.

When a user needs a vehicle at a later time or a pickup place at another location, the user may tap button 32 to open a window or page, where the user may enter pickup time or pickup location. Otherwise, Service Center may assume that the user needs a vehicle at current time and current location. A user may also tap button 34 to open a window or page and enter destination information, such as a street address or a name of a venue. Although destination info may not be necessary in a hailing process, some users may prefer to provide the info when reserving a vehicle, instead of giving it later or after getting in a vehicle. As aforementioned, if a user wants to share a vehicle with other users, destination info is required in a hailing or reservation process.

When a user needs a service in a vehicle, the user may tap button 36. Next a service page may appear, and the user may select one among several services available in an area. In the app interface, there is also a temporary button 38, which functions as an alert sign and an interactive element. Button 38, with a label containing an alert message such as “A parcel is ready”, only shows up in the interface when a parcel is available, i.e., when the app receives info from Service Center that a parcel is ready for delivery to the user. If there is no parcel ready for delivery, button 38 becomes invisible or doesn't show up in the interface. After the user taps button 38, a window or new page may appear where information about the parcel may be displayed, such as a name of the sender and the weight and dimensions of the parcel. Button 38 serves as an alert signal or reminder. It gives a recipient a notification and a relief to a certain extent and thus improves user experience.

It is noted that button 30, “Hail Car”, may be tapped at the beginning right after the app is launched or anytime afterwards. After button 30 is activated, the app may transmit a message to Service Center. The message may contain input given by a user besides info that is retrieved or collected automatically, like a user's name, account number, location, and request for hailing a vehicle. Hence, a user may tap button 30 before or after submitting pickup info, destination info, and/or a service request. Service Center may proceed differently depending upon information and requests it receives.

FIG. 3 shows another exemplary app interface according to the present invention. The interface shows up after button 36 of FIG. 2 is tapped. There are a title “Service Request” and button 30 at the top portion of the interface. As discussed, button 30 may be activated anytime to hail a vehicle without any input or with some input which a user may give via the app. A button 40 is configured beside button 30. The button is arranged for returning to a previous page. In a window 92 below button 30, there are interactive buttons 42, 44, 46, and 48 which are arranged as service options available in an area. Below the window area, button 38, still as a temporary alert sign or reminder, is configured when there is a parcel ready for delivery to a user. Again, when button 38 is tapped, another window or page may appear where information about a parcel may be displayed.

The buttons in window 92 represent services or business platforms provided for an area where a user is located in. A user may tap button 42 to enter another page and select food service options presented. Similarly, the user may tap button 44 or 46 to order a vehicle with massage or medical services. For instance, when button 44 or 46 is tapped, a page or window may appear in the interface. A list of massage or medical services may be presented. A user may tap an item to select one service. Button 48 is designed for selecting entertainment services which may include newly released movies, three-dimensional movies, virtual reality shows, or shows with special visual effects.

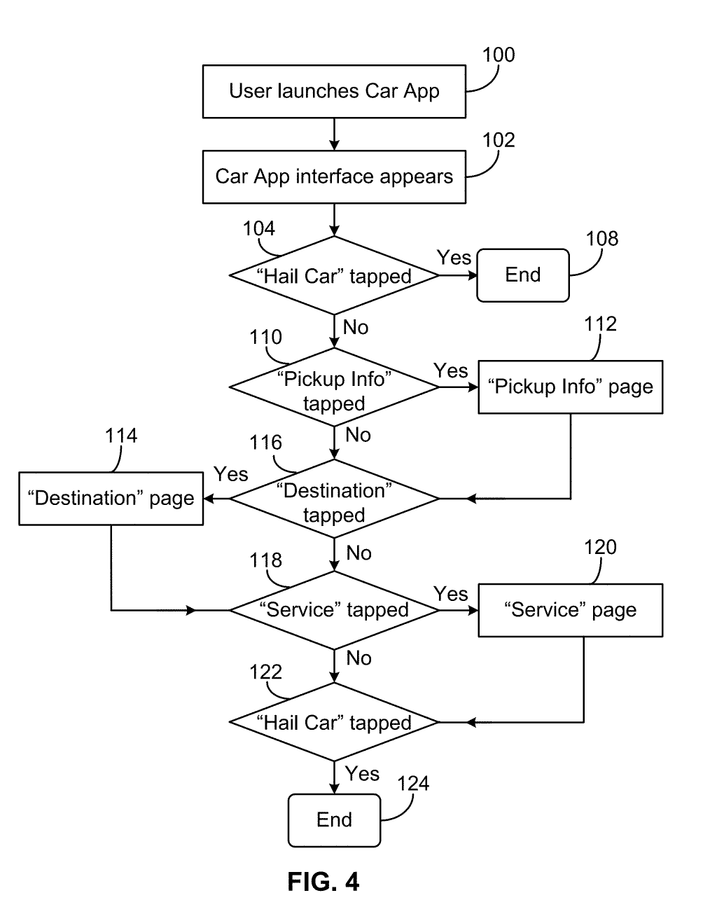

FIG. 4 is an exemplary flow diagram illustrating a vehicle hailing process according to the present invention. Assume that a user has set up an account after a registration process at Service Center. Car App, the app provided by Service Center for hailing a vehicle, is installed at an electronic device of the user. The device may be a smartphone or another smart gadget, for example. At step 100, the user opens the app and an app interface appears at step 102. The interface may resemble the one shown in FIG. 2. Then, the app starts monitoring whether the user submits any input. Input from a user may include a tap on an interactive button or element or anything entered via the app interface. At step 104, the user may tap a “Hail Car” button to hail a vehicle directly and the hailing process may end at step 108. As aforementioned, the user only needs to tap the “Hail Car” button to hail a vehicle. If the user doesn't tap the “Hail Car” button, the hailing process continues. At step 110, the user may tap a “Pickup Info” button. Then at step 112, a new page appears, such as a “Pickup Info” page, where info about pickup location and time may be entered. Next, the user may decide whether to enter destination info at step 116. For instance, the user may tap a “Destination” button to open a “Destination” page and then key in a destination address at step 114. If the user needs any service, a “Service” button may be tapped at step 118. Then the user may select one or multiple service options at a “Service” page at step 120. At the end, the user may tap “Hail Car” button to submit a hailing request at step 122, which also concludes the hailing process at step 124. After “Hail Car” button is tapped, the app may transmit to Service Center information which the user enters. In response, Service Center may send the user a confirmation message which may confirm a hailing request and provide information about a pickup vehicle.

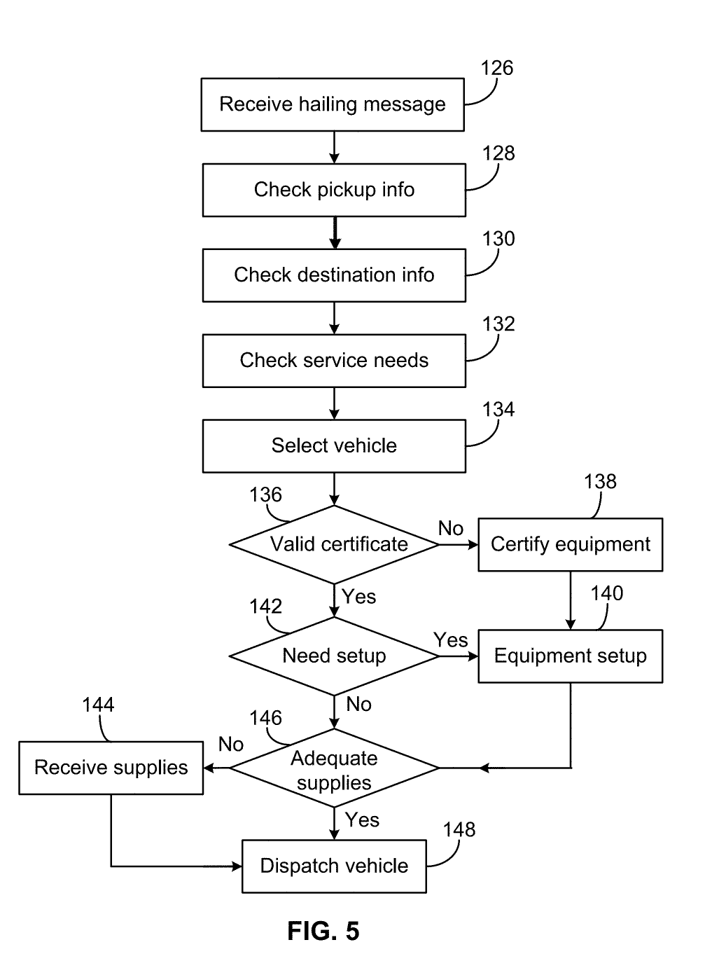

FIG. 5 shows another exemplary flow diagram according to the present invention. The diagram describes a process to handle a vehicle hailing request. Assume that Service Center receives a hailing or reservation message from a user at step 126. The message is sent from a device of the user via an app (like Car App) after the user taps a hail-car button. The hail-car button may function like button 30 of FIGS. 2 and 3. The message may contain a name of the user, an account number of the user, a request to hail a vehicle, location data of the device, and other information the user submitted or selected. Service Center then starts evaluating the message. At step 128, the center checks whether the message contains any info about pickup time and place. At step 130, the center checks whether the message includes any destination information. At step 132, a service option may be singled out if it is selected by the user. Again, a user may hail a vehicle without giving any information about pickup, destination, or service requests.

After reviewing info received from the user, Service Center may select a vehicle among a group of vehicles at step 134. The selected vehicle may have a business platform that provides services requested by the user. The platform may need certain equipment. Next at step 136, Service Center may check whether the equipment has a valid certificate. If a certificate expires already, the equipment may be certified again at step 138 and then go through a setup process at step 140. If the equipment's certificate is still valid, the center may check whether the equipment is set up properly at step 142. If set-up procedures are needed, step 140 is taken to make the equipment work properly. If the equipment doesn't need a certificate, steps 136 and 138 may be skipped. Next at step 146, the center may check whether the vehicle has adequate supplies of materials and consumable components to support a service. For instance, certain food supplies have to be maintained for food services in a vehicle. If the level of supplies is low, step 144 is taken and the vehicle gets re-stocked. Then at step 148, Service Center may send the vehicle to pick up the user.

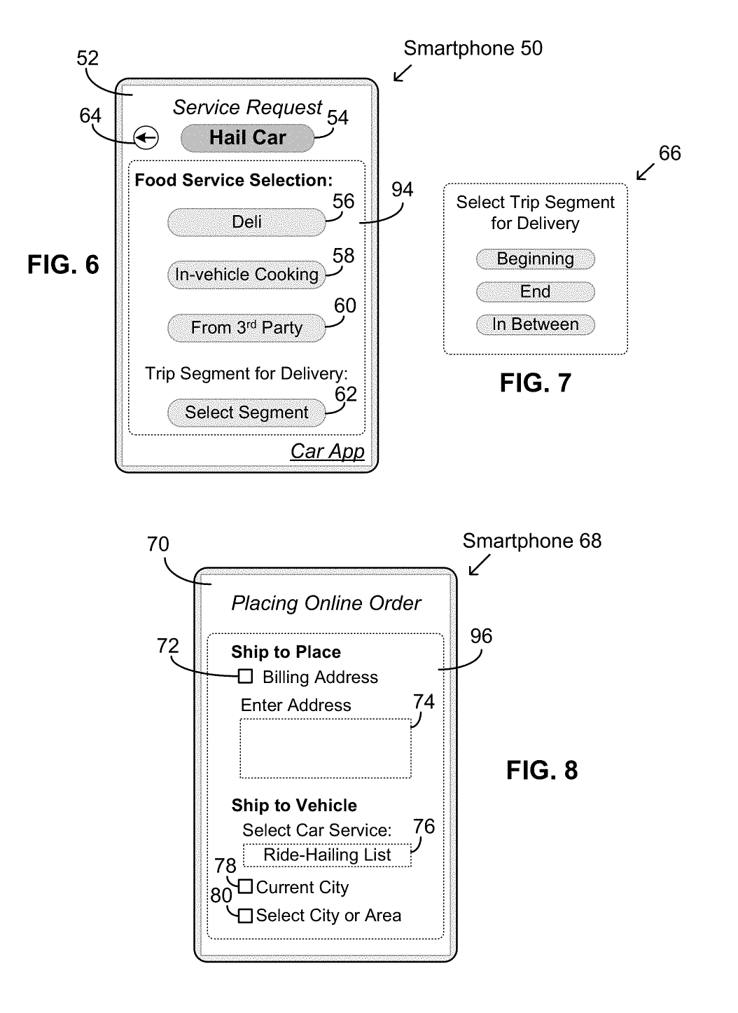

FIG. 6 shows an exemplary diagram of an app interface which depicts options of food services according to the present invention. Assume that the app is still Car App. A smartphone 50 is used as an electronic device to show the schemes. The interface appears after a user taps a food service button, like button 42 of FIG. 3, to request a food service. On a touch-sensitive screen 52 of the phone, a button 54 is configured for hailing a vehicle. A user may tap the button at any time to hail a vehicle and end a hailing process in the meantime. A button 64 is configured for returning to a previous page. In a window 94 below button 54, interactive buttons 56, 58, and 60 are presented as options of food services. The buttons each have a label to show a service category. For instance, deli, in-vehicle cooking, and third party are provided. When button 56 or 58 is tapped, another page may appear showing a list of dishes on a menu. When button 60 is tapped, a list of contracted restaurants may show up. A user may tap a restaurant icon to open a menu page and then choose dishes.

A user may place an order by tapping a button in each step. For instance, a user may tap button 58 to choose in-vehicle cooking and next a menu may show up in the interface. Assume that a menu item is spaghetti. The user may tap a “Spaghetti” button (not shown in the figure) to make a selection. Then the user may tap “Hail Car” button to submit a hailing request. When Service Center receives the hailing request along with a spaghetti order, the center may select a vehicle which is equipped with spaghetti cooking devices and has enough spaghetti supplies. For instance, the supplies may include spaghetti sauce and cooked plain spaghetti which may be stored in a refrigerator.

In window 94, a button 62 is also configured. Button 62 provides an option to select a trip segment for delivery. In real life, some users may want to receive a meal package at the beginning of a trip and some may like to have the package after arriving at a place. For instance, the former case may fit users rushing to a place around noon time. A user may have lunch while riding in a vehicle. The latter case may be favored by users going home after work. For instance, a user may place a takeout order at a restaurant and receive the order when a trip ends in front of his or her house. When button 62 is tapped, a window shows up, as depicted schematically in FIG. 7. FIG. 7 shows a window 66 which has a title “Select Trip Segment for Delivery” and three interactive buttons. The buttons may represent three trip sections as delivery options provided for a user. A user may tap a button to select the beginning of a trip, the end of a trip, or a segment in between. It may be designed that when an “In Between” button is tapped, a small window appears to take input from a user. The user may enter details to describe a desired delivery plan, such as delivering “within 5 minutes after the trip starts” or “around intersection of Main Street and First Avenue”. When a user doesn't enter any info in the small window, it may mean any time between the beginning and the end of a trip is okay for delivery.

When a hailed vehicle works as a parcel-delivery platform, it gives a user another option to ship an order besides conventional ways. The new option may be called ship-to-vehicle option, meaning that a parcel is shipped to a vehicle and delivered to an occupant of the vehicle, instead of being shipped to a physical address. FIG. 8 is an exemplary diagram describing schemes to select a shipping method. Again a smart phone is used as an electronic device in the example. Assume that a user uses a smartphone 68 to place an online order at a seller's website. An interface shown on a touch-sensitive screen 70 may represent a check-out page or screen view during the ordering process. Assume that some items are placed in a virtual shopping cart and it's time to choose a shipping method. After the interface is presented, the app monitors any input the user may submit. The user may enter a name of the recipient, who may be the user or another person. In a window 96, two shipping options are presented. A conventional method, “Ship to Place”, is configured at the top portion of the window. “Ship to Place” may mean a request to ship or deliver a parcel to a physical address. If a user wants the order to be delivered to his or her billing address, the user may check a box 72. Otherwise, the user may key in an address in a user input area 74. After box 72 is checked or info is entered in area 74, the user may proceed to the next page and enter other information such as payment info.

Alternatively, a user may choose the “Ship to Vehicle” method. With the “Ship to Vehicle” method, a ride-hailing company sends a parcel to a vehicle which a recipient is riding in, and then delivers the parcel to the recipient. As arranged herein, a ride-hailing company may serve as a transfer station or an intermediate link between a sender and a recipient. A user may tap a small window 76 to see a drop-down list. The list may contain active players in ride-hailing business. When the user taps a company on the list, the company is selected to act as an entity to transport and deliver the order, which also means the user chooses the ship-to-vehicle method. Two check boxes (not shown in the figure) may also be arranged for a user to select the ship-to-place or ship-to-vehicle option in the interface. A user may check one box to make a selection. Assume that the user is also the recipient in the example and the user has an account number at a selected ride-hailing company. If the seller doesn't have the user's account number, a window may pop up in the interface with a message asking the user to enter the account number. The reason is that a ride-hailing company may only deliver a parcel to an occupant of a vehicle, when the company can identify the occupant. In other words, the ship-to-vehicle method only works for recipients who are registered members of a ride hailing company or who can be identified by the company in advance.

When the seller lacks info of a recipient's account number of a ride-hailing company, an option may be presented in the interface for a user to enter it. When a user sends a parcel to another person, and doesn't know the person's account number at a ride-hailing company, the user may submit the person's physical address. After receiving a parcel, a ride-hailing company may verify whether a recipient is a registered member based on the recipient's name and address. If the recipient is not a registered member, the ride-hailing company may deliver the parcel to the recipient's address or let a shipping company to deliver it.

Return to FIG. 8. When the ship-to-vehicle option is selected, a parcel may be sent to a ride-hailing company or the company's vehicle first, and delivered to a recipient at the next step. After choosing a ride-hailing company, a user may check a box 78 or 80. When box 78 is checked, it means a user wants the parcel to be shipped to a city or area where the user is currently in. If the user wants to deliver the parcel to another city or area, box 80 should be checked and city or area name should be entered. After a user chooses the “Ship to Vehicle” method, the seller may send the info to a shipping company. Then the shipping company may contact a selected ride-hailing company after the parcel arrives at a local warehouse. At the final leg, either the shipping company or the ride-hailing company may transfer the parcel to a vehicle which a recipient is riding in. More details on shipping are discussed in the following section.

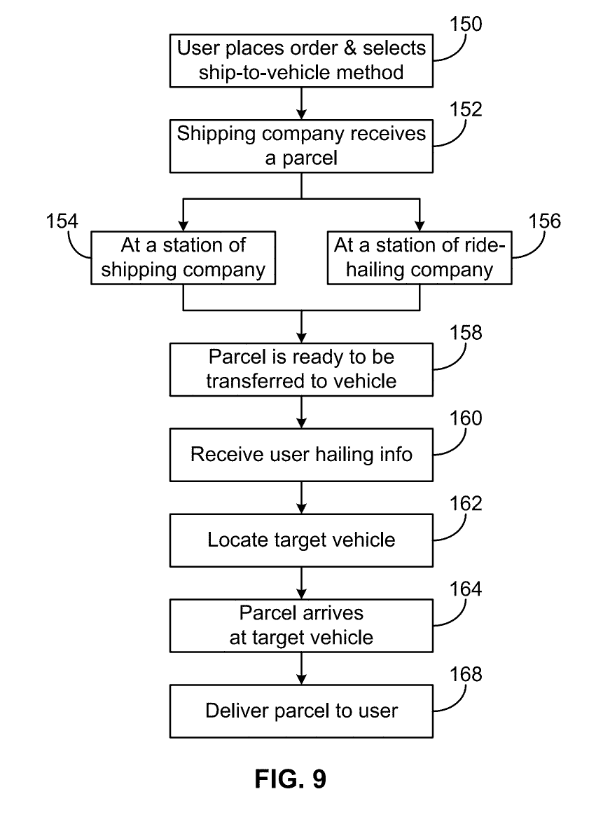

FIG. 9 shows a schematic flow diagram describing methods to ship a parcel according to the present invention. Assume that a user places a purchase order at a seller's website at step 150. The user is the recipient and wants to receive the order via a hailed vehicle, i.e., the user wants to use the ship-to-vehicle method. Next the user selects a ride-hailing company and submits the order. Afterwards, the seller prepares a parcel for the order, and passes the parcel to a shipping company at step 152. In a conventional way, the shipping company may ship the parcel to a physical address. Since the user chooses the ship-to-vehicle method, the shipping company plans to send the parcel to the selected ride-hailing company or to a vehicle of the ride-hailing company, depending upon a contract between the two entities. At step 154, which reflects the latter case, the parcel is sent to a local station of the shipping company. The parcel stays at the station until the user hails a vehicle. At step 156, which represents the former case, the parcel is sent to a local station of the selected ride-hailing company. Similarly, the parcel remains there until the user orders a vehicle.

At step 158, the parcel is ready for the next stage at a station of either the shipping or the ride-hailing company, i.e., ready to go to a vehicle assigned to the user. Assume that the ride-hailing company is managed by Service Center. Next, Service Center sends the user a message to inform him or her that a parcel is ready for delivery. At step 160, the center sends another message. The message is sent to either station which confirms that the user, who is the recipient as assumed here, has submitted a vehicle hailing request. For instance, Service Center may receive a message from a device of the user that the user entered a hailing request. Then at step 162, Service Center may receive info that a target vehicle is assigned to the user. The info may include description of the target vehicle, its current location, and a scheduled route. A target vehicle may detect its location by an onboard positioning system such as GPS and transmit location data to Service Center continuously. Service Center may send related data to the shipping company if the shipping company has the parcel and is scheduled to transfer the parcel to a target vehicle. Next Service Center or the shipping company dispatches a transport vehicle or drone to catch the target vehicle. It may be designed that Service Center may calculate to obtain a location or a segment of a road as a proposed transfer place and then arrange a target vehicle and a transport vehicle or drone to meet there. After some time, the transport vehicle or drone approaches the target vehicle and transfers the parcel to the vehicle at step 164. Next at step 168, the parcel is delivered to the user.

After a parcel arrives at a vehicle, the vehicle's control system may present a message to a user in there. The message may be presented on a touch screen with an announcement and a question, such as “Dear Mr. John Doe: A parcel arrives. Receive it now?”. Several buttons as brief answers may also be presented on the screen with labels like “Receive now”, “Receive at destination”, and “Refuse parcel”. When button “Receive now” is tapped, the parcel may be transfer to the user via a transfer device installed at the vehicle. When button “Receive at destination” is tapped, the user may pick up the parcel after a trip is completed. At destination, the user may get the parcel from a compartment inside the vehicle. The user may also get off the vehicle and open a cover of the vehicle to get the parcel. When a parcel has a large size, a user may have to get it from outside of a vehicle at the end of a journey. If button “Refuse parcel” is tapped, it may mean the user refuses to receive the parcel. Then the parcel may be returned to a sender.

It may be arranged that a user may select a trip segment for delivery when the user hails a vehicle, i.e., before a trip begins. For instance, when button 38 of FIGS. 2 and 3 is tapped, a selection window like window 66 of FIG. 7 may be displayed along with textual info about the parcel in the app interface. Hence, similar to previous discussions, a user may request to receive a parcel at a specific part of a trip, like at the beginning, the end, a certain time slot, or a segment of a journey. Such a request may be made whenever a user wants to do it before or after getting in a vehicle. A selection window like window 66 of FIG. 7 may also be configured in a check-out interface at an e-commerce website. For instance, options for trip segment selection may be arranged in window 96 of FIG. 8. Thus a user may choose a trip segment for delivery when placing a purchase order.

Furthermore, as there is a need to receive a parcel or order at a place, not in a vehicle, another option may be arranged in a selection window, such as window 66 of FIG. 7. For instance, two more buttons may be configured in the window, with labels like “Receive at Current Location” and “Receive at Another Location”. The former button may mean a user requests to receive a parcel at the present location. Once the button is tapped, address of a user's location may be presented and the user may add more detail to the address in an input area for a smooth delivery. Then the user may tap a button with a label like “Submit” to send the request to Service Center. The option may be desirable for users at home when there is a need to order a meal from a nearby restaurant. If the latter button is tapped, it may mean a user requests the parcel to go to another place. A user may enter a delivery address in an input space in the window and then tap the “Submit” button. Therefore, a user may decide to receive a parcel in a vehicle or at a place conveniently. The selection window may be configured in a purchasing or ordering interface, vehicle-hailing interface, or interface of a vehicle's control system.

When a package is too big or too heavy for a hailed vehicle to carry, such as larger than a given value, Service Center may notify a user that a parcel will be available at the end of a trip. In addition, an option to skip parcel delivery for a trip may be presented in an interface. For instance, a check box with a label “Don't delivery it this time” may be configured in a selection window, such as window 66 of FIG. 7. If a user wants to get a parcel later, the user may check the box to put the parcel on hold temporarily. Then Service Center may cancel a parcel delivery plan and wait for the next time. When a parcel is to be delivered at the end of a trip, either by a user's request or a decision made at Service Center, it becomes optional to transfer the parcel to a target vehicle. When arranging a delivery at the end of a trip, Service Center has two options if a parcel is suitable to be transferred to a target vehicle. The center may send the parcel to the target vehicle when the vehicle is on a road or send the parcel to the destination. In the latter case, Service Center may direct a transport vehicle or drone to a destination place and instruct it to meet a target vehicle or a user there. At a destination place, a parcel may be transferred to a target vehicle first. The target vehicle then delivers the parcel to a user. The transport vehicle or drone may also deliver a parcel to a user directly, without involvement of a target vehicle. Service Center may choose one between the two options based on predetermined rules.

In addition, when the dimensions or weight of a parcel is larger than a given value, it may be arranged that Service Center may ask for permission of a recipient before delivering it. The permission may prevent unnecessary waste of time and effort of a ride-hailing company. For instance, when a parcel is oversized, Service Center would not deliver it without getting permission or authorization from a recipient. To emphasize that a recipient's permission is required, another label may be assigned to button 38 of FIGS. 2 and 3 when there is an oversized parcel. The label may read, for example, “Authorization needed for delivery.” After the button is tapped, an authorization page may show up. A user may check a box or tap a button to allow Service Center to deliver it or check another box to postpone the delivery. For instance, when a user orders a big screen television for his or her apartment, the user may authorize delivery of the television when hailing a vehicle to return home.

As discussed, when a parcel is delivered at the end of a trip, a user may get the parcel from a transportation vehicle or drone which also arrives there. The transportation vehicle or drone may get info from Service Center and thus may know where a target vehicle may drop off a passenger and a proximate arrival-time slot. After a user gets off a target vehicle at a destination place, the user may follow instructions sent from Service Center and walk to the transport vehicle or drone which may be parked nearby. Next a parcel may be released after a code verification process or a facial recognition process is completed.

It is seen that both a shipping company and a ride-hailing company may send a parcel to a target vehicle. But a ride-hailing company may have advantages to do it, because communication between a transport vehicle and a target vehicle may be smoother when they belong to the same company.

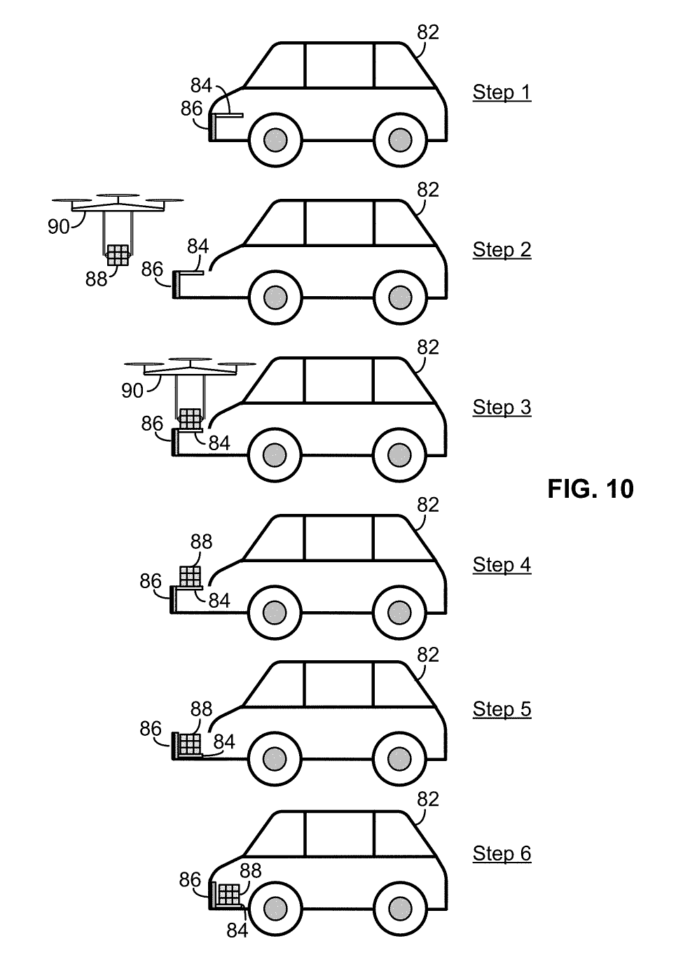

FIG. 10 shows exemplary diagrams to describe a parcel transfer process according to the present invention. Assume that a vehicle 82 is a target vehicle which a user rides in. The vehicle has a retractable landing pad 84 which is connected to a cargo door 86. Assume that at Step 1, a transport drone 90 finds vehicle 82. At Step 2, drone 90 with a parcel 88 approaches the vehicle. After communicating with drone 90, a control system of vehicle 82 may release pad 84 and push it out. The pad now is fully exposed and ready to receive a parcel, as shown in the figure. Next at Step 3, drone 90 places the parcel on pad 84. The parcel is secured on pad 84 at Step 4. Then at Step 5, pad 84 is lowered. And at Step 6, pad 84 is retracted, cargo door 86 is closed, and parcel 88 is transferred inside the vehicle. It is noted that the drone may be dispatched by a shipping company or a ride-hailing company.

As the flight of a drone may be affected by air turbulence, especially in a rainy or windy day, it may be arranged that a target vehicle may slow down below certain speed or stop at a place in order to receive a parcel safely and in a more secured and controlled way. For instance, Service Center may calculate to get an optimized transfer place where a parcel may be passed from a drone to a vehicle. And then the center may inform a target vehicle and a transport drone about the transfer place. The target vehicle may slow down or stop at the transfer place and meet the transport drone there. It is seen that a target vehicle may slow down or stop for other types of transport vehicles besides drones when a parcel needs to be transferred.

### Conclusion, Ramifications, and Scope

Thus it can be seen that systems and methods are introduced to provide services for a user in a vehicle.

The systems and methods have the following main features and advantages:
(1) A user may order a service when hailing a vehicle;
(2) A user may order cooking, massage, and medical services when hailing a vehicle;
(3) A user may receive a parcel when riding in a hailed vehicle;
(4) A user may select a ride-hailing company to deliver a parcel when placing a purchase order;
(5) An alert message or alert icon may be presented in a vehicle-hailing interface when a parcel is ready for delivery to a user; and
(6) A user may select a section of a trip to receive a parcel.

Although the description above contains many specificities, these should not be construed as limiting the scope of the invention but as merely providing illustrations of some of the presently preferred embodiments. Numerous modifications will be obvious to those skilled in the art.

### Ramifications:

Examples discussed herein apply to both autonomous vehicles and conventional vehicles with a driver.

A company may also be arranged to have the functionality of both ride-hailing and conventional shipping services. Consequently, a company may provide ride-hailing services for users, deliver parcels to vehicle occupants, and deliver parcels to physical addresses. For instance, when the company receives a parcel, it may check whether a sender selects the ship-to-vehicle or ship-to-place method. If the former is selected, the company may wait for a recipient to hail a vehicle and deliver the parcel when the recipient is in a hailed vehicle, assuming that the recipient has an account with the company. If the latter is selected or the recipient doesn't have an account, the parcel may be delivered to a physical address of the recipient.

When a company combines ride-hailing and conventional shipping capabilities together, it may deliver a parcel using either the ship-to-vehicle or ship-to-place method. It may choose one method based on a user's request or its own rules. In addition, a user may not be required to select one between the ship-to-vehicle and ship-to-place options. When submitting shipping info, a user may provide the name of a recipient, who may be the user or another person, the recipient's account number at the company, and a physical address of the recipient. A user may obtain an account number from a company, for instance, through a registration process at the company's website. The account number may be used for submitting a vehicle-hailing request. A user may enter a recipient's info through an interface of an e-commerce website or e-commerce app when placing an order. The interface may look like that shown in FIG. 8 with some modifications. On the other hand, a user may also just submit a recipient's name and account number or a recipient's name and address.

When a company, with combined ride-hailing and conventional shipping capabilities, receives a parcel, it may check the recipient's info first. If the company has the recipient's name, account number, and address, it may send the parcel to a vehicle and then deliver the parcel to the recipient when the recipient rides in the vehicle. As the company may send an alert message to the recipient before the delivery, the recipient may elect to receive the parcel in a vehicle or at a place. If the company has the recipient's name and account number only, it may have similar arrangement, i.e., delivering the parcel to the recipient when the recipient rides in a hailed vehicle. And again, the recipient may elect to receive the parcel in a vehicle or at a place. When the company only has the recipient's name and address, it may deliver the parcel to the address like a conventional shipping company does.

A vehicle may have multiple business platforms. For instance, a mini kitchen and a massage seat may be installed at a vehicle. A user may select both cooking and massage services in advance. Later on, the user may have a meal followed by a massage while riding in a vehicle.

A user may also hail a vehicle without installing an app like Car App at a device. As well-known, many electronic devices may run an app via a remote device or remote server. For instance, Service Center may prepare two apps, one for installation at a gadget and the other for remote access. The latter version may be designed with less data and processing demand and less complexity. It may enable a device to access a remote server and obtain needed contents of an app quickly. Examples of the latter version may include the mini programs, Instant Apps, or micro apps which are currently in practice.

Assume that a user uses an electronic device to access a hailing program at Service Center and runs the program to hail a vehicle. An app interface similar to that of FIG. 2 may be created on a screen of the device. The interface may have all the options provided by the interface of FIG. 2. The user may enter pickup and destination info via the interface. The user may also hail a vehicle without entering any info. For instance, after the app interface shows up, a user may use one tap to hail a vehicle by tapping a hailing button in the interface, like button 30 of FIG. 2. Assume that the user doesn't have a valid account at Service Center or the center doesn't know the user's account info. Assume that location option is enabled at the device. After the hailing button is tapped, a message is transmitted from the device to Service Center. The message only contains location info and a hailing request, as the user hasn't submitted any info yet. After Service Center gets the request, it may dispatch a vehicle to a place where the user is in and send a confirmation message to the user. The confirmation message may show up in the app interface, which may contain where and when a vehicle will arrive and a confirmation bar code or QR code. The bar code or QR code may be used for verification or identification when the user checks in a hailed vehicle. The user may provide destination and payment info to a control system of the hailed vehicle during or after a check-in process. Additionally, a user, who doesn't have an account number at Service Center, may also select one or more services via the app interface when hailing a vehicle.

Vehicle with one or more business platforms may be categorized and labeled. When a user requests a service, Service Center may filter available vehicles by a label and certain conditions to get a short list. Then the center may evaluate vehicles on the short list with more factors and select one for the user.

Assume that a shipping company and a ride-hailing company are operated separately. As FIG. 9 shows it, there are two ways to transfer a parcel to a vehicle, depending upon a contract between the two companies. If the ride-hailing company does it, the shipping company may ship the parcel to the ride-hailing company which then may send it to a local station waiting for the next step. Once the ride-hailing company receives a message that the recipient hails a vehicle and a target vehicle is chosen, it may transfer the parcel to the target vehicle.

On the other hand, if the shipping company is assigned to transfer the parcel to a target vehicle, the company may send related info to the ride-hailing company. The info may include a recipient's name, address, account number if available, and certain data about the parcel. In response, the ride-hailing company may send the shipping company a message which may specify an area where the parcel may be delivered. Then the shipping company may send the parcel to a station in or close to the area. Once the recipient hails a vehicle and a target vehicle is determined, the ride-hailing company may send another message to the shipping company. The message may contain location info of the target vehicle and a scheduled route. The ride-hailing company may send location info about the target vehicle continuously until a transport vehicle finds the target vehicle.

In above discussions, tapping a button is used to enter an input or interact with a system. As a client system or a control system of a vehicle may have a voice recognition mechanism, a user may use voice to replace tapping in above cases. For instance, a user may speak to a smartphone, instead of tapping buttons on a screen, to complete a vehicle hailing process or complete a hailing process and a service request. It is noted that a user may speak a few words or one sentence to complete a hailing process, which may resemble the one-tap hailing act. For instance, a user may open a hailing app by tapping a launch button or say something like “Start car hailing” to a smartphone. Next a hailing interface, like that of FIG. 2, may appear. The user may issue a voice request to hail a car using a few words. The user may say something like “Hail a car”, “Need a car”, or “Get me a car” without providing other info. The app may receive the voice input, interpret it via voice recognition techniques, and convert the voice input into the user's command. Then the hailing request, which is the same as that when a hailing button is tapped, is send to Service Center and the hailing process is completed in the meantime. Hence, a one-tap-to-hail-a-car process may be replaced by speaking a few words to hail a car.

If a user wants to enter pickup time in a hailing process, the user may say “Pickup time 10 am” and then a screen may show “Pickup time 10 am”, meaning the voice command is received. Similarly, more info may be entered via voice input, like destination information and a service request. For instance, after a user says “Service”, the act may equal to tapping a “Service” button and a service page may appear in the app interface. The user may proceed with more voice commands. In a similar way, a user may speak to a control system of a vehicle, instead of tapping buttons or keying in words on a touch-sensitive screen during or after a check-in process. For instance, a user may say “Give me the parcel now” after a message like “Parcel arrives” shows up on a screen when the user rides in a vehicle. Next a control system of the vehicle may send instructions to a parcel handling device. The handling device may deliver a parcel to the user or a message like “Please open parcel compartment” may show up on the screen. The user then may receive the parcel or open the compartment to get it.

It may be designed that before delivering a parcel to a user, a vehicle's control system may verify a code or confirm the user's identity. For instance, a user may key in a numerical code provided by Service Center on a screen of a vehicle or show a bar code or quick response (QR) code, which may be displayed on a screen of a smartphone, to a scanner of the vehicle. Service Center may send a code to a user in a confirmation email or message. Once a code, bar code, or QR code is verified, the control system may release a parcel. The control system may also take a picture of a user and conduct facial recognition to confirm the user's identity. After determining that the user is the recipient, the control system may send instructions to release a parcel.

Besides voice input, a tapping act may also be replaced by gesture instructions. When a device or a vehicle is equipped with a gesture sensor and gesture recognition mechanism, a user may gesture to choose and activate a button. Voice and gesture methods may be especially useful for VR and AR devices, as their screen is either virtual or too small to tap on it.

Furthermore, when Service Center schedules a user to ride in a vehicle with another user in a shared-vehicle case, the center actually arranges two strangers to meet each other “naturally”. Thus, a vehicle may also be configured to become a meet-new-friends platform or match-making platform and provide a meet-new-friends service. Before a user requests the service, the user may register at Service center, enroll in a meet-new-friends program, and provide certain personal info at Service Center. The personal info may include a user's profile, background, and preferences for a new friend. For instance, an icon may be configured in an interface of a vehicle-hailing app, such as Car App. The icon may have a label such as “Meet New Friends”. A user may tap the icon to enter an enrollment page, provide required info, and submit application for enrollment. After the application is approved by Service Center, the user may join the meet-new-friends program. If a user is in the meet-new-friends program, Service Center may select a suitable co-occupant for the user after the user hails a shared vehicle. It is assumed that the co-occupant is also enrolled in the meet-new-friends program. As a suitable co-occupant may not be available in many occasions, the other occupant in a vehicle may not be the one who enrolls in the program. Thus a user doesn't know whether or not the other occupant wants to start a relationship. Hence for a user enrolled in the meet-new-friends program, sharing a vehicle may remain as a neutral, natural and regular event without anxiety, pressure, and any burden.

After Service Center receives a request for a shared vehicle from a user, the center may check whether the user enrolls in a program for meeting new friends. If the answer is yes, the center may perform a matching process to pair the user with another requester. The match-making process may include several steps. The center may screen all shared vehicle requesters to select some whose route is close to the user's route. Then the center may screen the selected requesters one more time to get a list of candidates who also participate in the program and are willing to meet new friends. Next the center may retrieve personal info of the user and the candidates from a database at Service Center. The center may compare and analyze the data. If there is a match, i.e., one of the candidates fits conditions set forth by the user and vice versa, the center may assign a vehicle to both parties and send them confirmation messages respectively. Then the two parties may have a chance to meet each other and share a vehicle for some time on a trip. The conditions may include preferences of each party and certain requirements defined by Service Center. If there is no good match or a suitable co-occupant is unavailable, the center may pick another requester randomly based on route requirements only and send respective messages to both parties. In either case, a requester doesn't know whether the other occupant is enrolled in the meet-new-friends program. Thus a requester may treat the other occupant as an ordinary occupant and take a shared ride naturally and comfortably.

If a user likes the other occupant, the user may start a conversation. The user may also send a request to Service Center and request to contact the other occupant. If the other occupant allows messaging between occupants, which may be arranged as an optional item of the meet-new-friends program, a message may be sent to the other occupant along with info about the user. If the other occupant doesn't allow messaging between occupants, the user's request may be declined. Thus if a user doesn't want to be bothered by electronic messages from strangers or face an awkward situation when the two meet again afterwards and still wants to meet new friends, the user may check a box with a label like “No Messaging”. The box may be configured in an interface of the meet-new-friends program. After Service Center receives info that the box is checked by a user, messaging from other occupants to the user may be blocked.

Moreover, another option may be provided to a user enrolled in the meet-new-friends program. The option may be designed to allow Service Center to choose a route which may be longer than an optimized route by a given percentage, say twenty percent. For instance, after a user submits a request for a shared vehicle, Service Center finds out that the user is enrolled in the meet-new-friends program. Then Service Center may calculate an optimized route and a proposed route for the user. The optimized route may be calculated in a normal way, that is, without considering whether the other occupant is a good match for the user. First, Service Center may get routes of every requester of shared vehicle. Then the center may compare all routes obtained and find whether there is a route which matches the user's route to a certain extent. If there is one, Service Center may calculate a route based on routes of the user and the other requester. The calculated route may be called an optimized route that satisfies needs of both parties. Since the user is with the meet-new-friends program, Service Center may find another requester who is also in the program and the two are a good match to each other in terms of preferences and other predetermined factors. Assume that the other requester's route is farther away relatively. Then Service Center may calculate a proposed route. The proposed route may be longer than the optimized route and thus costs more or takes more time for the user. If the length of the proposed route is not longer than, for instance, twenty percent of the length of the optimized route, Service Center may pair the two together and arrange them to share a vehicle. If the length of the proposed route is longer than a given percentage, Service Center may discard the route and find another qualified requester. Service Center may also give up and select a requester not in the program if there is no good match. Since a proposed route may allow a user to have more chances to meet other users, users in the program may have incentive to spend more money or time to take it. Again, a check box may be configured in an interface of the program. A note like “Authorization for Longer Trip” may be placed beside a check box. If a user checks the box, an authorization is submitted and Service Center may arrange a route which is longer than an optimized journey. If a user doesn't check the box, the length increase of a proposed route may be maintained below a smaller value, say five percent. As a route of a shared vehicle may change each time, a user doesn't know whether it is an optimized route or proposed route. Thus the user doesn't know whether or not the other occupant is in the meet-new-friends program and may remain in a natural and easygoing state.

Lastly, it may also be designed that when a user taps button 98 of FIG. 2, another interface appears. The new interface may contain several check boxes as options provided for an occupant of a shared vehicle. For instance, one check box may have a description sentence “Same Gender Only”, which may mean a user requires that another occupant or the other occupants of a vehicle must be the same gender. And another check box may have a description sentence “Frequent Rider Only”, which may mean that a user requires that another occupant or the other occupants must qualify as a frequent rider at Service Center. Service Center may define a frequent rider as someone who hails a vehicle at least a given times a month for a given period of time such as six months. The options may benefit certain users who want to take precautions to lower safety risks, especially when a user hails a vehicle after dark. It is noted that a user may have to register at Service Center and submit own gender info in order to be allowed to select the gender requirement option.

Therefore the scope of the invention should be determined by the appended claims and their legal equivalents, rather than by the examples given.

1. A method performed at an electronic device for assisting a user in a vehicle hailing process, comprising:
1) presenting a plurality of contents in an interface, wherein the user hails or reserves a vehicle and submits information via the interface;
2) presenting an alert message or alert sign in the interface when there is a parcel ready for delivery to the user;
3) receiving input from the user in the vehicle hailing process; and
4) transmitting info of the input to a remote facility.

2. The method according to claim 1, further including presenting an interactive element as an option to request services in a vehicle.

3. The method according to claim 1, further including presenting a plurality of options for the user to select a trip segment as a parcel-delivery window.

4. The method according to claim 1, further including presenting an option for the user to choose cooking, massage, or medical service.

5. The method according to claim 1, further including providing an option for the user to enroll in a program, wherein the program is arranged for meeting new friends.

6. The method according to claim 1, further including providing an option for the user to allow route length increase under a given condition.

7. The method according to claim 1, further including providing an option for the user to choose a preference for another occupant in a shared vehicle.

8. A computer-implemented system comprising: one or more processors; and one or more memory devices coupled to the one or more processors, the one or more processors operable when executing certain instructions to:
1) present a plurality of contents in an interface, wherein a user hails or reserves a vehicle and submits information via the interface in a vehicle hailing process;
2) present an alert message or alert sign in the interface when there is a parcel ready for delivery to the user;
3) receive input from the user in the vehicle hailing process; and
4) transmit info of the input to a remote facility.

9. The system according to claim 8 wherein an interactive element is configured in the interface as an option to request services in a vehicle.

10. The system according to claim 8 wherein a plurality of options is provided for the user to select a trip segment as a parcel-delivery window.

11. The system according to claim 8 wherein an option is provided for the user to choose cooking, massage, or medical service.

12. The system according to claim 8 wherein an option is provided for the user to enroll in a program, the program arranged for meeting new friends.

13. The system according to claim 8 wherein an option is provided for the user to authorize route length increase under a given condition.

14. The system according to claim 8 wherein an option is provided for the user to choose a preference for another occupant in a shared vehicle.

15. A method for processing a vehicle hailing request via an electronic device, comprising:
1) receiving info about a parcel and an user, wherein the user is a recipient of the parcel;
2) sending a message to the user when the parcel is ready for delivery;
3) dispatching a vehicle to pick up the user in response to receiving a vehicle hailing request from the user; and
4) sending instructions to transfer the parcel to the vehicle.

16. The method according to claim 15 wherein the vehicle includes a business platform when the user requests a given service.

17. The method according to claim 15, further including selecting another occupant to share the vehicle with the user.

18. The method according to claim 15, further including selecting another occupant who matches the user under given conditions to share the vehicle when the user enrolls in a program for meeting new friends.

19. The method according to claim 15, further including sending information about the vehicle to a shipping company.

20. The method according to claim 15, further including calculating to obtain a place to transfer the parcel to the vehicle.
